(19) United States
(12) Patent Application Publication
(10) Pub. No.: US 2024/0378488 A1
(43) Pub. Date: Nov. 14, 2024

(54) ML MODEL POLICY WITH DIFFERENCE INFORMATION FOR ML MODEL UPDATE FOR WIRELESS NETWORKS

(71) Applicant: NOKIA TECHNOLOGIES OY, Espoo (FI)

(72) Inventors: Sakira Hassan, Espoo (FI); Afef Feki, Sceaux (FR); Endrit Dosti, Espoo (FI); Amaanat Ali, Espoo (FI); Jerediah Fevold, Chicago, IL (US)

(21) Appl. No.: 18/314,132

(22) Filed: May 8, 2023

(51) Int. Cl. G06N 20/00

(52) U.S. Cl. CPC G06N 20/00

(57) ABSTRACT

A method includes receiving, by a user device, a machine learning model policy associated with model update, wherein the machine learning model policy comprises at least one of the following: difference information for a machine learning model with respect to model structure or model configuration parameters; difference information with respect to one or more weights or biases of the machine learning model; or difference information with respect to one or more layers of the machine learning model; carrying out updating of the machine learning model according to the machine learning model policy; and transmitting, by the user device to a network node, information on at least one change to the machine learning model caused by the updating, for reducing overhead with respect to transmitting a full updated version of the machine learning model.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency. 6G and other networks are also being developed.

### SUMMARY

A method may include receiving, by a user device, a machine learning model policy associated with model update, wherein the machine learning model policy comprises at least one of the following: difference information for a machine learning model with respect to model structure or model configuration parameters; difference information with respect to one or more weights or biases of the machine learning model; or difference information with respect to one or more layers of the machine learning model; carrying out updating of the machine learning model according to the machine learning model policy; and transmitting, by the user device to a network node, information on at least one change to the machine learning model caused by the updating, for reducing overhead with respect to transmitting a full updated version of the machine learning model.

An apparatus may include at least one processor; and at least one memory including computer program code; the at least one memory and the computer program code configured to, with the at least one processor, cause the apparatus at least to: receive, by a user device, a machine learning model policy associated with model update, wherein the machine learning model policy comprises at least one of the following: difference information for a machine learning model with respect to model structure or model configuration parameters; difference information with respect to one or more weights or biases of the machine learning model; or difference information with respect to one or more layers of the machine learning model; carry out updating of the machine learning model according to the machine learning model policy; and transmit, by the user device to a network node, information on at least one change to the machine learning model caused by the updating, for reducing overhead with respect to transmitting a full updated version of the machine learning model.

A method may include receiving, by a network node from a user device, information indicating that the user device has a capability to perform at least one machine learning model updates based on difference information; transmitting, by the network node to the user device, a machine learning model policy associated with model update, wherein the machine learning model policy comprises at least one of the following, for reducing the overhead of with respect to transmitting a full machine learning model: difference information for a machine learning model with respect to model structure or model configuration parameters; difference information with respect to one or more weights or biases of the machine learning model; and difference information with respect to one or more layers of the machine learning model; and, receiving, by the network node from the user device, an indication of the at least one machine learning model update being carried out based on the machine learning model policy.

An apparatus may include at least one processor; and at least one memory including computer program code; the at least one memory and the computer program code configured to, with the at least one processor, cause the apparatus at least to: receive, by a network node from a user device, information indicating that the user device has a capability to perform at least one machine learning model update based on difference information; transmit, by the network node to the user device, a machine learning model policy associated with model update, wherein the machine learning model policy comprises at least one of the following, for reducing the overhead of with respect to transmitting a full machine learning model: difference information for a machine learning model with respect to model structure or model configuration parameters; difference information with respect to one or more weights or biases of the machine learning model; and difference information with respect to one or more layers of the machine learning model; and, receiving, by the network node from the user device, an indication of the at least one machine learning model update being carried out based on the machine learning model policy.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a user device (e.g., UE).

FIG. 3 is a flow chart illustrating operation of a network node (e.g., gNB).

FIG. 4 is a diagram illustrating the CDF (cumulative distribution function) values of weights of a first layer for model 1 and model 2.

FIG. 5 is a diagram illustrating some information of a model architecture.

FIG. 6 is a diagram illustrating example vector difference information as maximum difference values for multiple layers of a ML model.

FIG. 7 is a diagram illustrating operation of a user device (e.g., UE) and network node (e.g., gNB) for providing a ML model policy with difference information to the user device.

FIG. 8 is a diagram illustrating operation of network in which information is communicated by the UE to the gNB if the difference information was greater than a threshold.

FIG. 9 is a diagram illustrating operation of UE and gNB in which the gNB may obtain capability information of the UE to provide ML model policy with difference information based on capabilities of UE.

FIG. 10 is a block diagram of a wireless station or node (e.g., network node (such as gNB), user node or UE, relay node, or other node).

### DETAILED DESCRIPTION

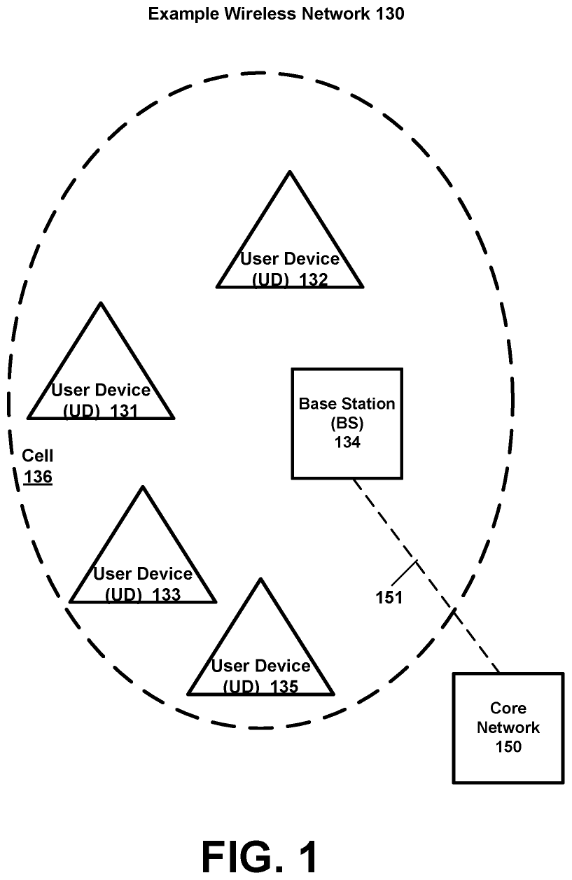

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as 5G (New Radio (NR)), cmWave, and/or mmWave band networks, IoT, MTC, eMTC, eMBB, URLLC, 6G, etc., or any other wireless network or wireless technology. These example networks, technologies or data service types are provided only as illustrative examples.

According to an example embodiment, a machine learning (ML) model may be used within a wireless network to perform (or assist with performing) one or more tasks or functions. In general, one or more nodes (e.g., BS, gNB, eNB, RAN node, user node, UE, user device, relay node, or other wireless node) within a wireless network may use or employ a ML model, e.g., such as, for example a neural network model (e.g., which may be referred to as a neural network, an artificial intelligence (AI) neural network, an AI neural network model, an AI model, a machine learning (ML) model or algorithm, a model, or other term) to perform, or assist in performing, one or more ML-enabled tasks. Other types of models may also be used. A ML-enabled task may include tasks that may be performed (or assisted in performing) by a ML model, or a task for which a ML model has been trained to perform or assist in performing).

ML-based algorithms or ML models may be used to perform and/or assist with performing a variety of wireless and/or radio resource management (RRM) functions or RAN functions to improve network performance, such as, e.g., in the UE for beam prediction (e.g., predicting a best beam or best beam pair based on measured reference signals), antenna panel or beam control, RRM (radio resource measurement) measurements and feedback (channel state information (CSI) feedback), link monitoring, Transmit Power Control (TPC), etc. In some cases, the use of ML models may be used to improve performance of a wireless network in one or more aspects or as measured by one or more performance indicators or performance criteria.

Models (e.g., neural networks or ML models) may be or may include, for example, computational models used in machine learning made up of nodes organized in layers. The nodes are also referred to as artificial neurons, or simply neurons, and perform a function on provided input to produce some output value. A neural network or ML model may typically require a training period to learn the parameters, i.e., weights, used to map the input to a desired output. The mapping occurs via the function. Thus, the weights are weights for the mapping function of the neural network. Each neural network model or ML model may be trained for a particular task.

To provide the output given the input, the neural network model or ML model should be trained, which may involve learning the proper value for a large number of parameters (e.g., weights) for the mapping function. The parameters are also commonly referred to as weights as they are used to weight terms in the mapping function. This training may be an iterative process, with the values of the weights being tweaked over many (e.g., thousands) of rounds of training until arriving at the optimal, or most accurate, values (or weights). In the context of neural networks (neural network models) or ML models, the parameters may be initialized, often with random values, and a training optimizer iteratively updates the parameters (weights) of the neural network to minimize error in the mapping function. In other words, during each round, or step, of iterative training the network updates the values of the parameters so that the values of the parameters eventually converge on the optimal values.

Neural network models or ML models may be trained in either a supervised or unsupervised manner, as examples. In supervised learning, training examples are provided to the neural network model or other machine learning algorithm. A training example includes the inputs and a desired or previously observed output. Training examples are also referred to as labeled data because the input is labeled with the desired or observed output. In the case of a neural network, the network learns the values for the weights used in the mapping function that most often result in the desired output when given the training inputs. In unsupervised training, the neural network model learns to identify a structure or pattern in the provided input. In other words, the model identifies implicit relationships in the data. Unsupervised learning is used in many machine learning problems and typically requires a large set of unlabeled data.

According to an example embodiment, the learning or training of a neural network model or ML model may be classified into (or may include) two broad categories (supervised and unsupervised), depending on whether there is a learning “signal” or “feedback” available to a model. Thus, for example, within the field of machine learning, there may be two main types of learning or training of a model: supervised, and unsupervised. The main difference between the two types is that supervised learning is done using known or prior knowledge of what the output values for certain samples of data should be. Therefore, a goal of supervised learning may be to learn a function that, given a sample of data and desired outputs, best approximates the relationship between input and output observable in the data. Unsupervised learning, on the other hand, does not have labeled outputs, so its goal is to infer the natural structure present within a set of data points.

Supervised learning: The computer is presented with example inputs and their desired outputs, and the goal may be to learn a general rule that maps inputs to outputs. Supervised learning may, for example, be performed in the context of classification, where a computer or learning algorithm attempts to map input to output labels, or regression, where the computer or algorithm may map input(s) to a continuous output(s). Common algorithms in supervised learning may include, e.g., logistic regression, naive Bayes, support vector machines, artificial neural networks, and random forests. In both regression and classification, a goal may include finding specific relationships or structure in the input data that allow us to effectively produce correct output data. As special cases, the input signal can be only partially available, or restricted to special feedback: Semi-supervised learning: the computer is given only an incomplete training signal: a training set with some (often many) of the target outputs missing. Active learning: the computer can only obtain training labels for a limited set of instances (based on a budget), and also may optimize its choice of objects for which to acquire labels. When used interactively, these can be presented to the user for labeling. Reinforcement learning: training data (in form of rewards and punishments) is given only as feedback to the program's actions in a dynamic environment, e.g., using live data.

Unsupervised learning: No labels are given to the learning algorithm, leaving it on its own to find structure in its input. Some example tasks within unsupervised learning may include clustering, representation learning, and density estimation. In these cases, the computer or learning algorithm is attempting to learn the inherent structure of the data without using explicitly-provided labels. Some common algorithms include k-means clustering, principal component analysis, and auto-encoders. Since no labels are provided, there may be no specific way to compare model performance in most unsupervised learning methods.

In many cases, a network or network node (e.g., such as a gNB or other network node) may train and/or store a ML model. A UE may request the ML model, and then the ML model may be transferred or provided by the gNB to the UE. The UE may then use the ML model to perform a function (e.g., RAN-related function, such as beam prediction or other RAN-related function) or task. In addition, due to various changes that may occur in the environment (or other changes), the data used to train the ML model may become obsolete. This may cause the ML model to become inaccurate and/or have degraded performance of a RAN-related function. For example, the gNB or network may detect the diminished performance of the ML model at the UE, which may trigger the gNB to re-train or update the ML model, or the gNB may simply periodically re-train or update the ML model.

Various information may be stored regarding a ML model, such as, for example: 1) weights and/or biases of the model (these are adjusted or adapted during training or re-training of the ML model); 2) an architecture of the ML model, e.g., such as a type of ML model (e.g., a convolutional model), a number of layers for the model, a number of weights and/or biases per layer, for example; and/or 3) a state of the model, which may include a training configuration (e.g., which may include various configuration parameters or hyper-parameters) and/or checkpoints that may be used to resume training or re-training.

AI/ML based solutions may apply for many use cases in radio access networks, where already initial cases are identified in the standard 3GPP in RAN1 and RAN3 (including energy saving, CSI compression, beam management as examples). In order to ensure the desired ML model performance in all conditions and environments variations, occasional ML model updates or re-training may be required to ensure a high level of performance for the ML model that may be deployed at one or more UEs.

A ML model update may include or refer to a re-estimation of the ML model parameters realized through model retraining or refinement. In some cases, the ML model update may be performed by a different entity (at the network, such as at a gNB or other network entity) than the node (e.g., UE) that is using or applying the ML model in inference mode to perform or assist in performing a RAN-related function. Thus, in such a case, the updated model may typically need to be transferred from a network node to the UE. However, in some cases, only some aspects, such as a very limited portion of ML model parameters, may be updated. In such a case, the transfer of the complete updated ML model from the network to the UE may be viewed as unnecessary, or at least considered an inefficient use of radio resources. More efficient techniques are desirable to transfer a ML model update.

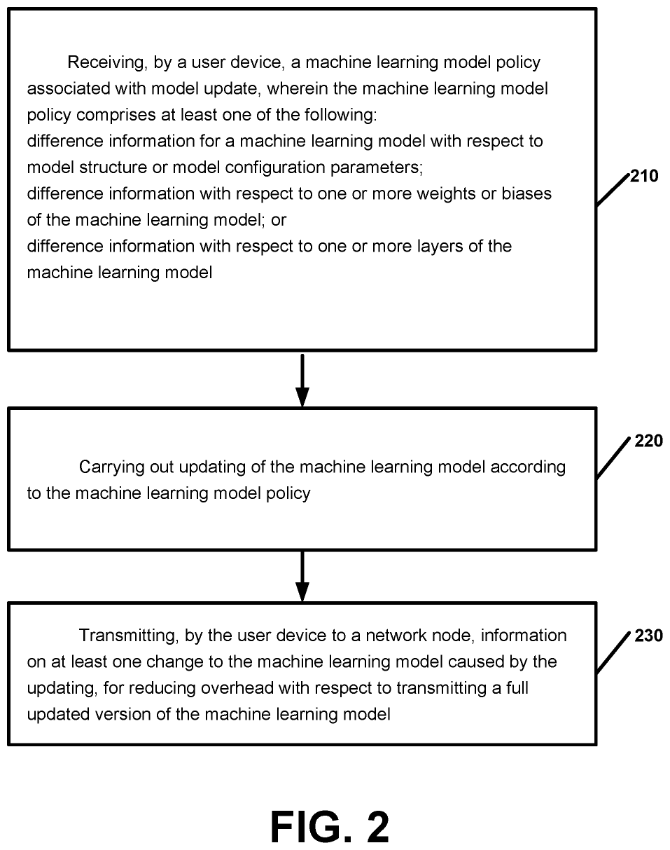

FIG. 2 is a flow chart illustrating operation of a user device (e.g., UE). Operation 210 includes receiving, by a user device (e.g., UE), a machine learning (ML) model policy associated with model update, wherein the machine learning model policy comprises at least one of the following: difference information for a machine learning model with respect to model structure or model configuration parameters; difference information with respect to one or more weights or biases of the machine learning model; or difference information with respect to one or more layers of the machine learning model. Operation 220 includes carrying out (or performing), by the user device (or UE) updating of the machine learning model according to the machine learning model policy. Operation 230 includes transmitting, by the user device (or UE) to a network node (e.g., a gNB), information on at least one change to the machine learning model caused by the updating, for reducing overhead with respect to transmitting a full updated version of the machine learning model.

With respect to the method of FIG. 2, wherein the difference information with respect to model structure or model configuration parameters may include difference information that indicates an amount or percentage that one or more of the configuration parameters of the machine learning model should be increased or decreased; wherein the difference information with respect to one or more weights or biases of the machine learning model may include difference information provided for the machine learning model that indicates an amount or percentage that weights and/or biases of the machine learning model should be increased or decreased; and wherein the difference information with respect to one or more layers of the machine learning comprises difference information provided for each of one or more layers of the machine learning model that indicates an amount or percentage that weights and/or biases of the layer of the machine learning model should be increased or decreased.

With respect to the method of FIG. 2, the method may further include transmitting, by the user device (e.g., UE) to the network node (e.g., gNB), a request for the machine learning model policy; and wherein the receiving comprises receiving the machine learning model policy based on the request.

With respect to the method of FIG. 2, wherein the machine learning model may include a first version of the machine learning model, and wherein the difference information includes a difference or delta between one or more weights, biases or layers of the first version of the machine learning model and one or more weights, biases or layers, respectively, of a second version of the machine learning model that is obtained based on the updating the first version of the machine learning model based on the difference information.

With respect to the method of FIG. 2, the difference information may include: a global difference information indicating a global difference for the machine learning (ML) model (e.g., for the full or complete ML model, such as for all layers of the ML model) between one or more aspects or parameters of the first version of the machine learning model and one or more corresponding aspects or parameters of the second version of the machine learning model.

With respect to the method of FIG. 2, the difference information with respect to one or more layers may include a vector difference information (e.g., difference information for each of one or more layers or one or more parameters) indicated for each of one or more layers, including difference information for one or more parameters of the layer of the machine learning model.

With respect to the method of FIG. 2, the difference information with respect to one or more layers may include difference information indicated for each of one or more layers, including a first difference information for weights of the layer, and a second difference information for biases of the layer of the machine learning model. For example, a difference information, provided per layer or for one or more layers of the ML model, may indicate an amount of change, such as an amount of increase or decrease, to be performed on weights (or other parameters that may be indicated) of the indicated layer to update the ML model. For example, the ML model policy may include difference information provided for layers 1, 3, 5-8, and 10-14 of an ML model (as a simple illustrative example, since a ML model may include any number of layers).

With respect to the method of FIG. 2, the difference information may include an indication of one or more layers of the machine learning model that are updated. For example, this difference information may indicate that, e.g., only layers 1-5, 9-12 and 38-44 were updated.

With respect to the method of FIG. 2, the difference information may include a per parameter difference information for a subset of one or more weights or biases of the machine learning model. For example, difference information, e.g., indicating an amount or percentage that a weight should be adjusted (e.g., increased or decreased) may be provided only for an indicated subset of weights and/or only for specific layers of a ML model.

With respect to the method of FIG. 2, the difference information may include a difference or change in a state of the machine learning model, including an updated state or a change in a state of one or more parameters (e.g., such as one or more hyper-parameters, or a state of the ML model) of the machine learning model, which may be used by the user device for training or updating the machine learning model.

With respect to the method of FIG. 2, the difference information may include information indicating a relationship between two or more consecutive layers of the machine learning model that have been updated. For example, this difference information may indicate that weights of layer 3 are increased the same amount as weights of layer 2, or the weights of layer 3 are increased 10% more than the weights of layer 2. Other difference information may be indicated.

With respect to the method of FIG. 2, the difference information may include a correlation of weights and/or biases between consecutive layers of the machine learning model. For instance, the difference information may include the similarity or dissimilarity in embedded spaces between consecutive layers, where embedding is the transformation of higher dimensional parameters (weights, biases) to lower dimensions.

With respect to the method of FIG. 2, the difference information may include at least one of a maximum difference for each layer of the machine learning model, before and after being updated; a linear or non-linear computation (a statistical computation such as mean squared error, cumulative distribution function; a cosine function; a correlation, etc.) indicating an amount or percentage that weights and/or biases of the machine learning model should be changed; a correlation of weights and/or biases between multiple layers of the machine learning model; a mean squared error, a maximum difference value, a percentile cumulative distribution function, or a cosine function that indicates an amount that weights and/or biases of the machine learning model should be changed; or a mean squared error, a maximum difference value, or a percentile cumulative distribution function provided for each layer, that indicates an amount that the weights and/or biases of one or more layers of the machine learning model should be changed.

With respect to the method of FIG. 2, the machine learning model may include a first version of the machine learning model, wherein the difference information comprises at least one of: a maximum difference between weights of the first version of the machine learning model and weights of a second version of the machine learning model after being updated; a linear or non-linear computation indicating a difference between weights and/or biases of the first version of the machine learning model and weights and/or biases of the second version of the machine learning model; a mean squared error, a maximum difference value, a percentile cumulative distribution function, or a cosine function that indicates differences between weights and/or biases of the first version of the machine learning model and weights and/or biases of the second version of the machine learning model; or a mean squared error, a maximum difference value, or a percentile cumulative distribution function provided for each of one or more layers, that indicates differences between weights and/or biases of a layer of the first version of the machine learning model and weights and/or biases of a same or corresponding layer of the second version of the machine learning model.

With respect to the method of FIG. 2, the transmitting, by the user device to the network node, information on at least one change to the machine learning model caused by the updating may include transmitting, by the user device to the network node, information indicating at least one of the following: that one or more layers of the machine learning model were updated based on the difference information; an indication of one or more weights and/or biases that were updated based on the difference information; an amount that one or more weights and/or biases of the machine learning model were changed; an indication that weights and/or biases of the machine learning model were changed by more than a threshold; or an indication of one or more layers of the machine learning model for which weights and/or biases of the layer were changed by more than a threshold.

Also, for example, the user device (or UE) may perform the update to the ML model based on the received difference information. The UE may measure or calculate a measured difference information (e.g., of parameters, such as weights, for the complete mode, or per layer), and determine which of these measured difference information is greater than a threshold, and then report or transmit to the network node the measured difference information that are greater than the threshold. Two examples are described below.

With respect to the method of FIG. 2, the machine learning model may include a first version of the machine learning model, wherein the carrying out updating comprises updating, by the user device based on the difference information, the machine learning model to obtain a second version of the machine learning model. The method may further include determining, by the user device, a measured general difference information based on a difference between weights of the second version of the machine learning model and the weights of the second version of the machine learning model; and comparing the measured general difference information to a threshold; and wherein the transmitting information on at least one change to the machine learning model comprises transmitting, by the user device to the network node, the measured general difference information to a network node if the measured general difference information is greater than the threshold.

With respect to the method of FIG. 2, the machine learning model may include a first version of the machine learning model, wherein the carrying out updating comprises updating, by the user device based on the difference information, the machine learning model to obtain a second version of the machine learning model. The method may further include determining, by the user device, a measured per layer difference information based on a difference, per layer, between weights of the second version of the machine learning model and the weights of the second version of the machine learning model; comparing, for each layer of the machine learning model, each measured per layer difference information to a threshold; wherein the transmitting information on at least one change to the machine learning model comprises transmitting, by the user device to the network node, the measured per layer difference information, for one or more of the layers that have a measured per layer difference information that is greater than the threshold.

With respect to the method of FIG. 2, the user device may transmit or provide (e.g., in response to a capabilities request message from the network node), a capabilities indication that indicates the user device has the capability to perform updating of the ML model, and/or has the capability to perform updating of the ML model based on difference information. Different types or levels of difference information may be supported by the UE. Different types or levels or difference information may include, e.g., per model difference information (e.g., which may indicate a change for all weights and/or biases of the ML model), per layer difference information (e.g., which may indicate a difference or a change of weights and/or biases for each of multiple indicated layers). The type or level of difference information supported by the user device or UE may be indicated in the capabilities indication, and may include, e.g., an indication that UE supports only difference information at the complete or full model level (e.g., weights of the ML model should be increased 20% to perform the update, and/or that the user device supports per layer difference information (e.g., layer 1 weights should be increased 10%, while layer 2 weights should be decreased 15%)). These are just some illustrative examples of how the user device or UE may provide a capabilities indication to perform ML model update based on various types or levels of difference information.

For example, with respect to the method of FIG. 2, the method may include transmitting, by the user device to the network node, a capabilities indication that indicates at least one of the following: that the user device has a capability to perform the updating of the machine learning model; that the user device has a capability to perform the updating of the machine learning model based on difference information; that the user device has a capability to perform the updating of the machine learning model based on the machine learning model policy that includes the difference information for the machine learning model with respect to the model structure or model configuration parameters; that the user device has a capability to perform the updating of the machine learning model based on the machine learning model policy that includes difference information with respect to one or more layers of the machine learning model; and/or that the user device has a capability to perform the updating of the machine learning model based on the machine learning model policy that includes difference information with respect to one or more biases or weights of the machine learning model.

With respect to the method of FIG. 2, the method may further include receiving, by the user device from the network node, the machine learning model policy that includes the difference information that is based on or in accordance with the capabilities indication transmitted by the user device. The user device or UE, for example, may perform the ML model update based on the ML model policy (which includes the difference information).

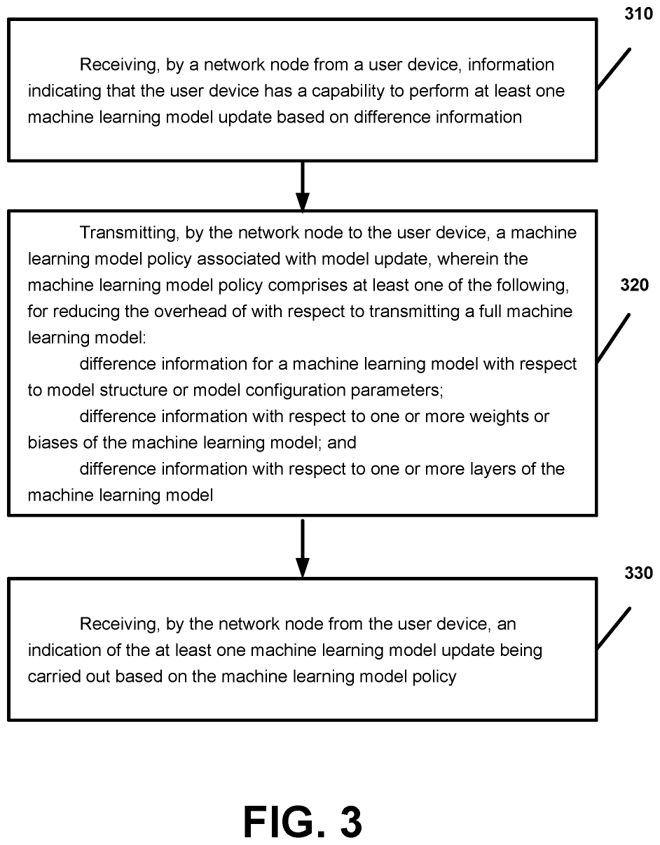

FIG. 3 is a flow chart illustrating operation of a network node (e.g., gNB). Operation 310 includes receiving, by a network node (e.g., gNB) from a user device (e.g., UE), information indicating that the user device has a capability to perform machine learning model updates based on difference information. Operation 320 includes transmitting, by the network node to the user device, a machine learning model policy associated with model update, wherein the machine learning model policy includes at least one of the following, for reducing the overhead of with respect to transmitting a full machine learning model: difference information for a machine learning model with respect to model structure or model configuration parameters; difference information with respect to one or more weights or biases of the machine learning model; and difference information with respect to one or more layers of the machine learning model. Operation 330 includes receiving, by the network node from the user device, an indication of an update that was performed by the user device on the machine learning model based on the machine learning model policy.

Thus, with respect to the method of FIG. 3, the gNB or network node may receive a capabilities indication from the UE indicating that the UE has a capability to perform machine learning model updates based on difference information supports (can perform) ML model capability update, such as an indication that the UE can perform ML model update based on one or more types or levels of difference information, such as one or more of the types or levels of difference information indicated above. The gNB may then transmit or provide the ML model policy including difference information (e.g., including difference information of one or more types or levels that are supported by the UE for model update). The UE may perform at least one ML model update based on the ML model policy (e.g., including the UE supported difference information). The gNB may then receive from the UE an indication of at least one update that was performed by the UE on the machine learning model based on the machine learning model policy (which may be or may include various kinds or types of information provided by the UE).

With respect to the method of FIG. 3, as noted, the UE may provide the gNB an indication that the user device can perform at least one ML model update based on one or more types or levels of difference information (e.g., the capabilities indication provided by the UE may indicate which of these levels or types of difference information are supported by the UE for model update). Thus, the capabilities indication provided by the user device or UE may include an indication of at least one of the following: that the user device has a capability to perform the updating of the machine learning model; that the user device has a capability to perform the updating of the machine learning model based on difference information; that the user device has a capability to perform the updating of the machine learning model based on the machine learning model policy that includes the difference information for the machine learning model with respect to the model structure or model configuration parameters; or that the user device has a capability to perform the updating of the machine learning model based on the machine learning model policy that includes difference information with respect to one or more layers of the machine learning model; and/or that the user device has a capability to perform the updating of the machine learning model based on the machine learning model policy that includes difference information with respect to one or more biases or weights of the machine learning model.

With respect to the method of FIG. 3, the transmitting, by the network node to the user device, the machine learning model policy may include: transmitting, by the network node to the user device, the machine learning model policy that includes difference information that is based on or in accordance with the capabilities indication received by the network node from the user device. Thus, as noted, the gNB may send or provide to the user device (or UE) a ML model policy that includes a type or level of difference information that is supported by the user device.

With respect to the method of FIG. 3, the method may further include receiving, by the network node from the user device, information on, or relating to, at least one change performed by the user device to the machine learning model based on the machine learning model policy. This information may include various types of information relating to the update of the ML model performed by the UE, e.g., such as information indicating an amount of change performed on weights or biases for the ML model, an indication of one or more layers for which weights or biases were updated or changed, and/or other information. Also, for example, as noted, the user device (or UE) may perform the update to the ML model based on the received difference information. The UE may measure or calculate a measured difference information (e.g., of parameters, such as weights, for the complete mode, or per layer), and determine which of these measured difference information is greater than a threshold, and then may report or transmit to the network node the measured difference information that are greater than the threshold (e.g., such as an indication of which layers had measured difference information greater than the threshold).

With respect to the methods of FIGS. 2-3, a ML model policy that is provided by the gNB to a UE may include difference information, which may indicate or describe a difference(s) between a first ML model and a second (or updated) ML model. Thus, based on first ML model (which the UE already has received), and the difference information, the UE may update the first ML model to obtain or estimate the second (updated) ML model. This may provide technical advantage of allowing ML model update without requiring the gNB to transmit the full updated ML model. In this manner, less signaling or overhead and/or less radio resources are required to transmit the ML model policy that includes the difference information, as compared to transmission of the full updated ML model. Said another way, transmitting the model policy including difference information provides technical advantage of reducing overhead (e.g., reducing signaling and/or radio resource overhead) required for UE to receive information that is required to obtain or perform the ML model update, as compared to (or with respect to) the gNB transmitting the complete updated ML model to the UE.

The text and figures described hereinbelow provide further illustrative examples, features and/or operations with respect to the methods of FIGS. 2-3.

For example, the difference information may include one or more of the following: an indication of indices of model layers which are updated (if this information is provided, the UE may retrain only those layers, or may request further information); an indication of the ML model's performance accuracy and/or intermediate performance indicator(s) (this may provide further information, and may indicate an amount that parameters of the model should be changed to obtain the updated ML model, e.g., adjust weights by 25% if CDF is 1.25, for example); an indication of difference information for those model parameters (e.g., weights or biases) that are changed or updated; an indication of the difference of the model parameters as well as state of the model, including one or more updated hyper-parameters, such as e.g., learning rate, loss of accuracy, to allow the UE to continue retraining the ML model from the current state, and/or any model structure change (e.g., such as increase or decrease layers or change model type); an indication of a relationship between consecutive layers of the ML model which have been changed as part of the retraining or updating; and/or an indication of a difference in the relationship of each of the consecutive layers of the ML model before and after the ML model is retrained or updated.

As noted, the ML model policy may include one or more types or levels of difference information. Some illustrative examples are described below. Considering two models, model 1 (a first model, or original model) and model 2 (the updated model) having a same architecture (e.g., a same type of ML model, and/or having a same number of layers), the difference information may be provided (for example) as either 1) a global difference information, and/or 2) a vector difference information. These will be briefly described, and are only two examples, of various types of difference information that may be included within the ML model policy.

Global difference information: a value or representation translating (or indicating) a difference between corresponding parameters (e.g., weights, biases or other parameter) of model 1 and model 2. Thus, global difference information (which may also be referred to as general difference information), may be provided for the model, or at the model level. Thus, the term global, within global difference information, may indicate that the difference information is for (or applicable to) the full model, not just a specific layer or layers (in contrast with vector difference information described below). Global (or general) difference information may indicate a global (applicable for the model, e.g., the full or complete model, not just some layer or portion of the model) difference for the machine learning model between one or more aspects or parameters (e.g., weights, for example) of model 1 (or a first version of the ML model) and model 2 (or a second version of the ML model). The global difference information may include difference information with respect to one or more weights or biases of the machine learning model, e.g., indicating a difference or change in weights between model 1 and model 2. The global difference information with respect to one or more weights or biases of the ML model may include difference information provided for the ML model that indicates an amount or percentage that weights and/or biases of model 1 should be increased or decreased to obtain or estimate model 2, for example.

For example, global difference information may include one or more of the following illustrative examples: a maximum difference between weights of the first version of the machine learning model and weights of a second version of the machine learning model after being updated; a linear or non-linear computation indicating a difference between weights and/or biases of model 1 (the first version of the machine learning model) and weights and/or biases of model 2 (the second version of the machine learning model); a mean squared error, a maximum difference value, a percentile cumulative distribution function, or a cosine function that indicates differences between weights and/or biases of model 1 and weights and/or biases of model 2.

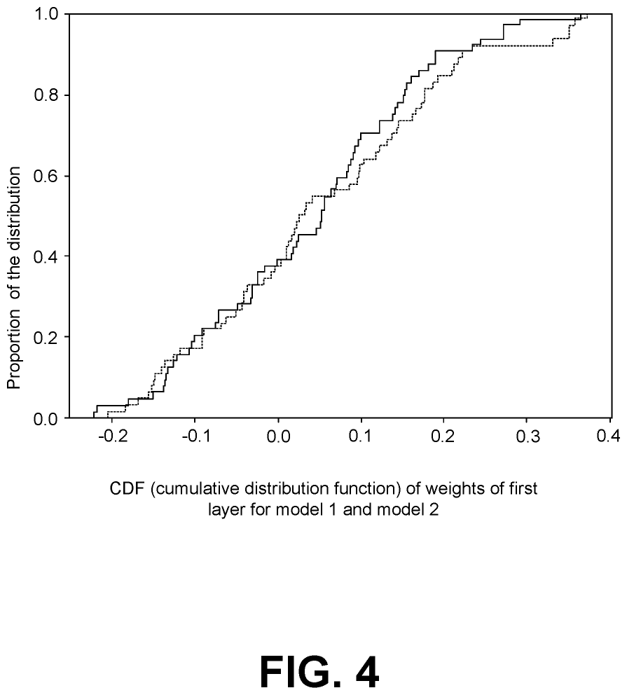

Also, for example, global difference information may be or may include a value (e.g., a unique value) translating the difference between the weights of model 1 and model 2, e.g., such as mean squared error value (MSE) or maximum difference value or the selected percentile cumulative distribution function (CDF) value of the difference (e.g., see example in FIG. 4 below showing a CDF of the weights of two models, the difference value here may be 95% percentile value 0.25).

Vector difference information: a value or representation translating (or indicating) a difference (or translating the details of the difference) per layer between model 1 and model 2. Thus, vector difference information may be provided per layer, or a difference value for each layer (or for one or more layers). Thus, vector difference information may include, e.g., a difference or change between weights of layer 1 of model 1 and weights of layer 1 of model 2. Thus, vector difference information may provide difference information at the layer level, or per layer of the ML model, for example. For example, vector difference information may include per layer information, such as a mean squared error, a maximum difference value, or a percentile cumulative distribution function provided for each of one or more layers, that indicates differences between weights and/or biases of a layer of model 1 (the first version of the ML model) and weights and/or biases of a same or corresponding layer of model 2 (the second version of the ML model). Or, for example, vector difference information may indicate a correlation of weights and/or biases between consecutive layers of the machine learning model, or a rate of change of correlation between weights and/or biases of consecutive layers of the machine learning model that has been updated (e.g., indicating a change or update of weights of one layer as correlation to, or as being correlated with, the changes to consecutive or adjacent layer of the ML model). For example, based on this correlation (e.g., 100% correlation) between consecutive layers 1 and 2, if layer 1 of model 1 is increased by 20% to obtain model 2, and there is a correlation between layer 2 and layer 1, then this informs the UE that layer 2 weights should also be increased by 20%, for example, to obtain the layer 2 of the model 2 (or updated model). Other values of correlation may be used as well, e.g., 50% correlation (where layer 2 weights would be adjusted by 50% of the adjustment amount applied to layer 1 weights, for example). Or, for example, vector difference information may include information indicating a relationship between two or more consecutive layers of the machine learning model that have been updated (e.g., correlation is one example of relationship, but other relationships may be indicated or used). Thus, for example, a vector difference information may include a value or representation that indicates or translates the difference per layer, such as a mean squared error, or other value or indication.

Two illustrative examples will now be described.

### Example 1

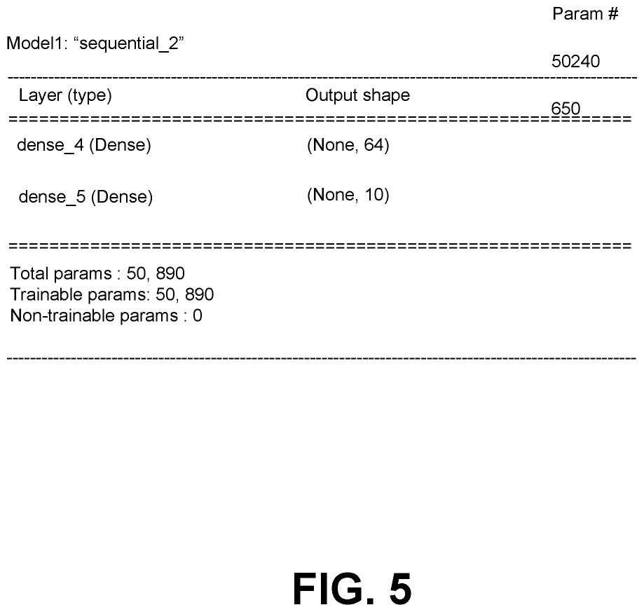

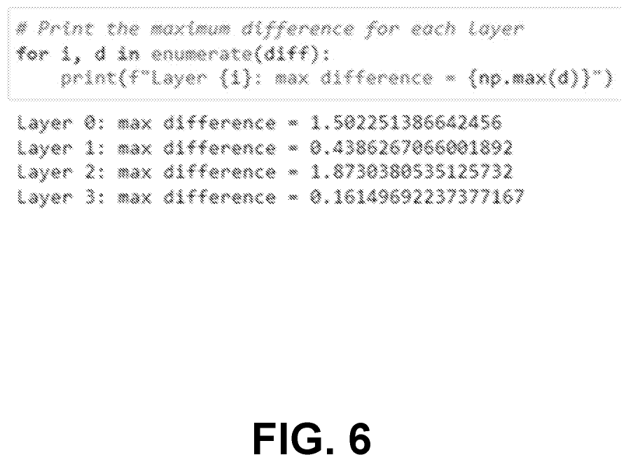

Model 1 (the original model) and model 2 (the updated model) with input size=784, and output size=10, with the same architecture indicated by FIG. 5. A preliminary experiment was performed on MNIST dataset, which contains handwritten digits. Each digit in this example dataset is represented with 2 dimensional images with height and weight as 28×28. Therefore, there are 784 input shapes which gives the total number of weights for the input layer. Since there are 10 digits, the output shape is 10 in the output layer. FIG. 4 is a diagram illustrating, in horizontal (or x) axis, the CDF (cumulative distribution function) values of weights of a first layer for model 1 and model 2, with the CDF value may be a 95th percentile CDF value of 0.25. The vertical (or y) axis of FIG. 4 is the proportion of the distribution which measures the proportion of the weights to occur. A calculation of the maximum difference (which may be the difference information) is listed in the chart of FIG. 6. Thus, the difference information listed in the chart of FIG. 6 provides examples of vector difference information, as an example.

### Example 2

Model 1 (the original model) and model 2 (the updated model) with a total of 500 parameters (e.g., 500 weights). Model 2 is obtained after update or re-training of model 1, where 350 parameters values are the same (unchanged), and 150 parameters values are changed or updated. Thus, the difference information should indicate or translate this difference between model 1 weights and model 2 weights, either via: 1) a global difference information, indicating a cumulative distribution function (CDF) value at selected threshold 95 percentile, or a mean squared error (MSE) (between total weights of model 1 and model 2. Thus, the UE can obtain updated ML model 2 based on this difference information and ML model 1; or 2) a vector difference information providing a more detailed view of the model difference information, since this vector difference information may be provided at the layer level (per layer, or provided for each layer). The vector difference information may include the difference value and the layer index identifying the layer to which the difference information corresponds or is for.

As noted, a ML model may be updated at an entity (e.g., gNB) that is different from the entity (e.g., UE) that is using or applying the ML model in inference mode to perform a RAN-related function. Thus, for example, in order to decrease signaling and radio resource overhead, rather than sending the complete updated ML model, the gNB may send a ML model policy that includes difference information to allow the UE to perform at least one ML model update or re-training. Also, for example, in a case of vector difference information, the difference values for each layer may be compared to a threshold, and then only those difference values greater than the threshold are sent to the UE as part of the ML model policy, e.g., to provide even more signaling efficiency for the transfer of the difference information. Also, in the case of global (or general) difference information, the difference information for the whole model (e.g., for all the weights for the ML model), may be compared to a threshold, and then the global difference information is sent to the UE if the global difference information is greater than a threshold (otherwise, there is no need to perform the ML model update if the global difference information is small or trivial).

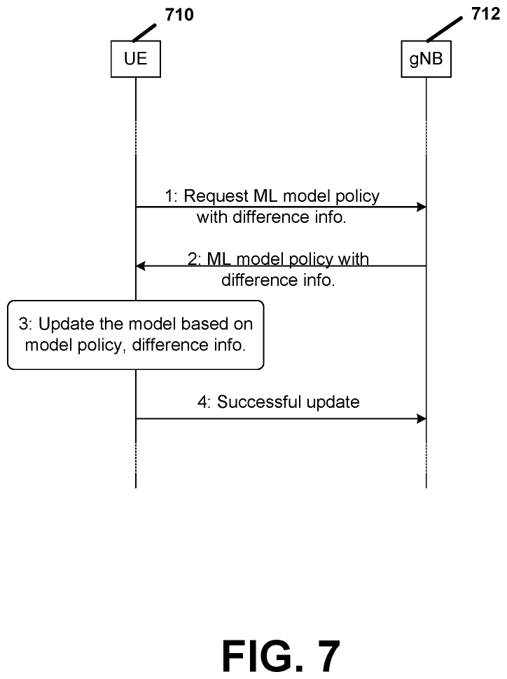

FIG. 7 is a diagram illustrating operation of a user device (e.g., UE) and network node (e.g., gNB) for providing a ML model policy with difference information to the user device. A UE 710 may be in communication with a gNB 712. At 1), UE 710 may send a request for a ML model policy or update information, e.g., such as requesting a ML model policy with difference information. At 2), gNB 712 provides or transmits the ML model policy with difference information to the UE 710 At 3) the UE 710 may update the ML model based on the ML model policy, including the difference information. At 4), UE 710 may send an acknowledgement message or successful update message to gNB 712 to indicate that the ML model policy was updated.

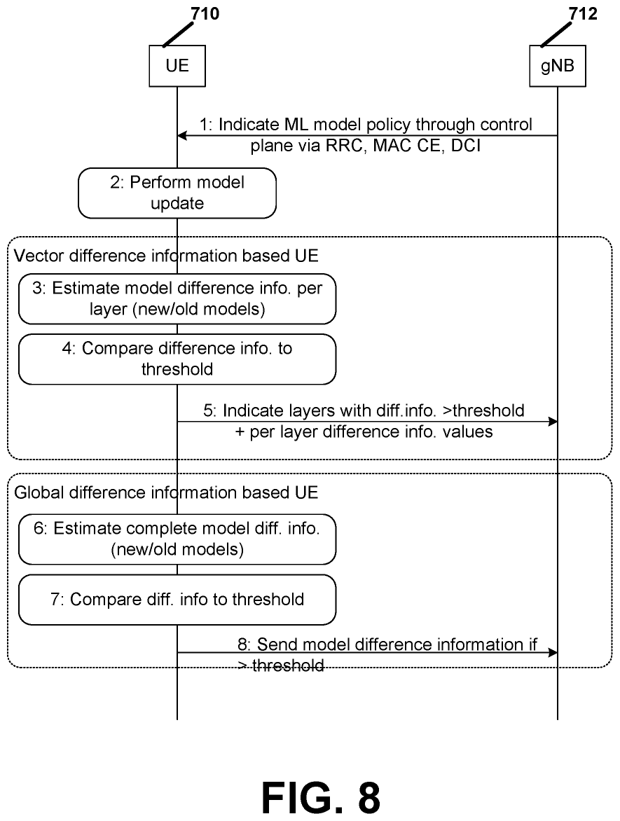

FIG. 8 is a diagram illustrating operation of network in which information is communicated by the UE to the gNB if the difference information was greater than a threshold. At 1) gNB 712 may provide or transmit the ML model policy with difference information, such as transmitting this information via control plane, e.g., such as via RRC (radio resource control message), MAC-CE (media access control-control element), and/or DCI (downlink control information via PDCCH). At 2), the UE 710 may perform ML model update based on the difference information received within the ML model policy. Also, within FIG. 8, two options are shown, including an option where the difference information comprises vector difference information or global difference information. Depending on the capability of the UE and/or based on the type of difference information that is communicated to the UE, different types of processing may be performed by the UE. Operations 3)-5) are for the case where the UE receives vector difference information and operations 6)-8) are for the case where the UE receives global difference information. At 3), the UE may determine a measured vector (or per layer) difference information for each of one or more layers, as a difference between weights of updated model and original model (per layer). At 4) each of the measured vector (or per layer) difference information may be compared to a threshold. And at 5), the UE 710 may transmit the measured vector (or per layer) difference information to the gNB 712. At 6), the UE may determine a measured global (or general) difference information as the difference between weights of the original model (model 1) and weights of the updated model (model 2). This global or general difference information for the ML model is compared to a threshold at 7). At 8), the UE transmits this measured global (or general) difference information to gNB 712 if this measured global or general difference information is greater than the threshold.

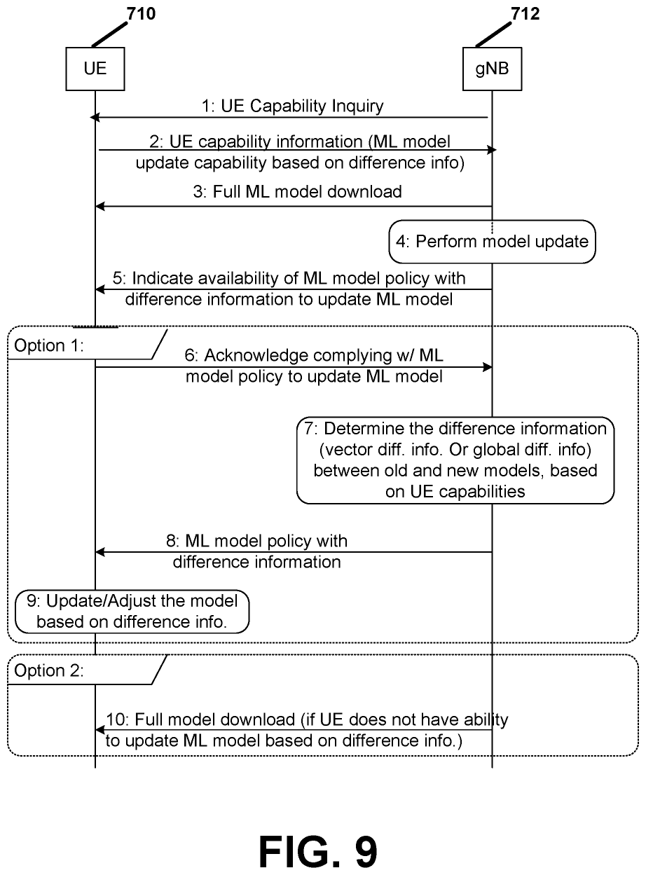

FIG. 9 is a diagram illustrating operation of UE and gNB in which the gNB may obtain capability information of the UE to provide ML model policy with difference information based on capabilities of UE. At 1)-2), the UE 710 receives a capability inquiry from gNB 712, and replies with a UE capability response message indicating the UE's capability to update ML model based on difference information. UE may also indicate support for different types or levels of difference information, such as global difference information and/or vector difference information. At 3), the gNB 712 provides to UE 710 a full ML model download (e.g., of the original model, or model 1). At 4), gNB 712 may perform a ML model update. At 5) the gNB 712 may indicate to the UE 710 an availability of the ML model policy. Operation 6) may be optional, and may include UE providing an indication that it will comply with update of ML model based on ML model policy with difference information. At 7), the gNB 712 may determine difference information based on the updated model, the original model and the UE capabilities. The difference information determined by the gNB 712 may include either global (or general) difference information based on weights of the whole model (between the two models), or vector difference information based on weights (or other parameters) per layer, between the two models. At 8), the gNB 712 may transmit the difference information to the UE 710. At 9), the UE may update or adjust the original model (or model 1), to obtain the updated model (or model 2) based on the received difference information. At option 2, if the UE is incapable of perform ML model updates based on difference information (e.g., as indicated by the UE at 2), the gNB 712 may provide to UE 710 a full ML model download or transfer for the updated ML model.

Some examples will now be described, based on the description and figures provided herein.

Example 1. A method comprising: receiving (210, FIG. 2), by a user device (e.g., UE 710, FIGS. 7-9), a machine learning model policy associated with model update, wherein the machine learning model policy comprises at least one of the following: difference information for a machine learning model with respect to model structure or model configuration parameters; difference information with respect to one or more weights or biases of the machine learning model; or difference information with respect to one or more layers of the machine learning model (thus, different types of levels of difference information may be used); carrying out updating (e.g., step 220 of FIG. 2, UE 710 performing at least one update) of the machine learning model according to the machine learning model policy (e.g., model update of step 3, FIG. 7, operation 2 of FIG. 8, or update model operation 9 of FIG. 9); and transmitting (e.g., step 230, FIG. 2), by the user device (UE 710) to a network node (e.g., gNB 712, FIGS. 7-9), information on at least one change to the machine learning model caused by the updating, for reducing overhead with respect to transmitting a full updated version of the machine learning model (e.g., UE may send gNB various information on the update of the ML model, such as an indication confirming the ML model update was performed (e.g., message 4 of FIG. 7), or information indicating which parameters and/or layers of the ML model were updated (see message 5 or message 8 of FIG. 8), and/or indicating measured difference information for one or more layers or weights/parameters). By receiving ML model policy including difference information (upon which the UE may perform ML model update) instead of full updated ML model, signaling and/or radio resource overhead may be reduced (e.g., as compared to receiving the full updated ML model from the gNB).

Example 2. The method of Example 1: wherein the difference information with respect to model structure or model configuration parameters comprises difference information that indicates an amount or percentage that one or more of the configuration parameters of the machine learning model should be increased or decreased; and wherein the difference information with respect to one or more weights or biases of the machine learning model comprises difference information provided for the machine learning model that indicates an amount or percentage that weights and/or biases of the machine learning model should be increased or decreased; and wherein the difference information with respect to one or more layers of the machine learning comprises difference information provided for each of one or more layers of the machine learning model that indicates an amount or percentage that weights and/or biases of the layer of the machine learning model should be increased or decreased.

Example 3. The method of any of Examples 1-2, further comprising: transmitting (e.g., operation 1 of FIG. 7), by the user device to the network node, a request for the machine learning model policy; and wherein the receiving comprises receiving (operation 2 of FIG. 7) the machine learning model policy based on the request.

Example 4. The method of any of Examples 1-3, wherein the machine learning model comprises a first version of the machine learning model (e.g., ML model 1), and wherein the difference information comprises a difference or delta between one or more weights, biases or layers of the first version of the machine learning model and one or more weights, biases or layers, respectively, of a second version of the machine learning model (e.g., ML model 2, or the updated ML model) that is obtained based on the updating the first version of the machine learning model based on the difference information.

Example 5. The method of Example 4, wherein the difference information comprises: a global difference information (e.g., see global difference information, FIG. 8) indicating a global difference for the machine learning model between one or more aspects or parameters (e.g., weights, or other parameter) of the first version (e.g., ML model 1 or original ML model) of the machine learning model and one or more corresponding aspects or parameters of the second version of the machine learning model (e.g., ML model 2 or updated ML model).

Example 6. The method of any of Examples 1-5, wherein the difference information with respect to one or more layers comprises a vector difference information indicated for each of one or more layers, including difference information for one or more parameters of the layer of the machine learning model.

Example 7. The method of any of Examples 1-6, wherein the difference information with respect to one or more layers comprises difference information indicated for each of one or more layers, including a first difference information for weights of the layer, and a second difference information for biases of the layer of the machine learning model.

Example 8. The method of any of Examples 1-7, wherein the difference information comprises an indication of one or more layers of the machine learning model that are updated.

Example 9. The method of any of Examples 1-8, wherein the difference information comprises a per parameter difference information for a subset of one or more weights or biases of the machine learning model.

Example 10. The method of any of Examples 1-9, wherein the difference information comprises a difference or change in a state of the machine learning model, including an updated state or a change in a state of one or more parameters of the machine learning model, to be used by the user device for training or updating the machine learning model.

Example 11. The method of any of Examples 1-10, wherein the difference information comprises information indicating a relationship between two or more consecutive layers of the machine learning model that have been updated.

Example 12. The method of any of Examples 1-11, wherein the difference information comprises: a correlation of weights and/or biases between consecutive layers of the machine learning model.

Example 13. The method of any of Examples 1-12, wherein the difference information comprises at least one of: a maximum difference (e.g., see maximum difference values indicated for layers 0, 1, 2, 3, in FIG. 6) for each layer of the machine learning model, before and after being updated; a linear or non-linear computation indicating an amount or percentage that weights and/or biases of the machine learning model should be changed; a correlation of weights and/or biases between multiple layers of the machine learning model; a mean squared error, a maximum difference value, a percentile cumulative distribution function, or a cosine function that indicates an amount that weights and/or biases of the machine learning model should be changed; or a mean squared error, a maximum difference value, or a percentile cumulative distribution function provided for each layer, that indicates an amount that the weights and/or biases of one or more layers of the machine learning model should be changed.

Example 14. The method of any of Examples 1-13, wherein the machine learning model comprises a first version of the machine learning model, wherein the difference information comprises at least one of a maximum difference (e.g., see FIG. 6) between weights of the first version of the machine learning model and weights of a second version of the machine learning model after being updated; a linear or non-linear computation indicating a difference between weights and/or biases of the first version of the machine learning model and weights and/or biases of the second version of the machine learning model; a mean squared error, a maximum difference value, a percentile cumulative distribution function, or a cosine function that indicates differences between weights and/or biases of the first version of the machine learning model and weights and/or biases of the second version of the machine learning model; or a mean squared error, a maximum difference value, or a percentile cumulative distribution function provided for each of one or more layers, that indicates differences between weights and/or biases of a layer of the first version of the machine learning model and weights and/or biases of a same or corresponding layer of the second version of the machine learning model.

Example 15. The method of any of Examples 1-14, wherein the transmitting, by the user device to the network node, information on at least one change to the machine learning model caused by the updating comprises transmitting, by the user device to the network node, information indicating at least one of the following: that one or more layers of the machine learning model were updated based on the difference information; an indication of one or more weights and/or biases that were updated based on the difference information; an amount that one or more weights and/or biases of the machine learning model were changed; an indication that weights and/or biases of the machine learning model were changed by more than a threshold; or an indication of one or more layers of the machine learning model for which weights and/or biases of the layer were changed by more than a threshold.

Example 16. The method of any of Examples 1-15, wherein the machine learning model comprises a first version of the machine learning model, wherein the carrying out updating comprises updating, by the user device based on the difference information, the machine learning model to obtain a second version of the machine learning model; the method further comprising: determining, by the user device, a measured general difference information based on a difference between weights of the second version of the machine learning model and the weights of the second version of the machine learning model; and comparing the measured general difference information to a threshold; and wherein the transmitting information on at least one change to the machine learning model comprises transmitting, by the user device to the network node, the measured general difference information to a network node if the measured general difference information is greater than the threshold.

Example 17. The method of any of Examples 1-16, wherein the machine learning model comprises a first version of the machine learning model, wherein the carrying out updating comprises updating, by the user device based on the difference information, the machine learning model to obtain a second version of the machine learning model; the method further comprising: determining, by the user device, a measured per layer difference information based on a difference, per layer, between weights of the second version of the machine learning model and the weights of the second version of the machine learning model; comparing, for each layer of the machine learning model, each measured per layer difference information to a threshold; wherein the transmitting information on at least one change to the machine learning model comprises transmitting, by the user device to the network node, the measured per layer difference information, for one or more of the layers that have a measured per layer difference information that is greater than the threshold.

Example 18. The method of any of Examples 1-17, further comprising: transmitting, by the user device to the network node, a capabilities indication that indicates at least one of the following: that the user device has a capability to perform the updating of the machine learning model; that the user device has a capability to perform the updating of the machine learning model based on difference information; that the user device has a capability to perform the updating of the machine learning model based on the machine learning model policy that includes the difference information for the machine learning model with respect to the model structure or model configuration parameters; that the user device has a capability to perform the updating of the machine learning model based on the machine learning model policy that includes difference information with respect to one or more layers of the machine learning model; and/or that the user device has a capability to perform the updating of the machine learning model based on the machine learning model policy that includes difference information with respect to one or more biases or weights of the machine learning model.

Example 19. The method of Example 18, and further comprising: receiving, by the user device from the network node, the machine learning model policy that includes the difference information that is based on or in accordance with the capabilities indication transmitted by the user device.

Example 20. An apparatus comprising: at least one processor; and at least one memory including computer program code; the at least one memory and the computer program code configured to, with the at least one processor, cause the apparatus at least to perform the method of any of Examples 1-19.

Example 21. A non-transitory computer-readable storage medium comprising instructions stored thereon that, when executed by at least one processor, are configured to cause a computing system to perform the method of any of Examples 1-19.

Example 22. An apparatus comprising means for performing the method of any of Examples 1-19.

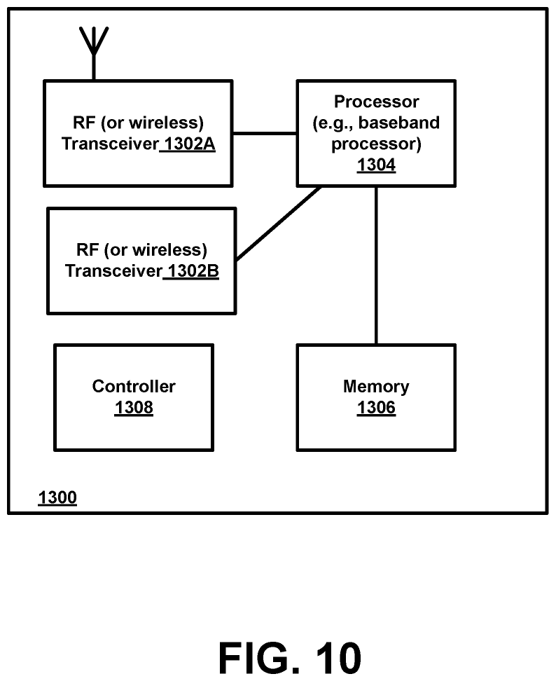

Example 23. An apparatus (e.g., see FIG. 10) comprising: at least one processor (e.g., 1304, FIG. 10); and at least one memory (e.g., 1306, FIG. 10) including computer program code; the at least one memory and the computer program code configured to, with the at least one processor, cause the apparatus at least to: receive, by a user device, a machine learning model policy associated with model update, wherein the machine learning model policy comprises at least one of the following: difference information for a machine learning model with respect to model structure or model configuration parameters; difference information with respect to one or more weights or biases of the machine learning model; and difference information with respect to one or more layers of the machine learning model; carry out updating of the machine learning model according to the machine learning model policy; and transmit, by the user device to a network node, information on at least one change to the machine learning model caused by the updating, for reducing overhead with respect to transmitting a full updated version of the machine learning model.

Example 24. A method comprising: receiving (310, FIG. 3), by a network node (e.g., gNB 712, FIGS. 7-9) from a user device (e.g., UE 710), information indicating that the user device as a capability to perform at least one machine learning model update based on difference information; transmitting, by the network node to the user device, a machine learning model policy associated with model update, wherein the machine learning model policy comprises at least one of the following, for reducing the overhead of with respect to transmitting a full machine learning model: difference information for a machine learning model with respect to model structure or model configuration parameters; difference information with respect to one or more weights or biases of the machine learning model; and difference information with respect to one or more layers of the machine learning model; and receiving, by the network node from the user device, an indication of the at least one machine learning model update being carried out based on the machine learning model policy.

Example 25. The method of Example 24, wherein the capabilities indication comprises an indication of at least one of the following: that the user device has a capability to perform the updating of the machine learning model; that the user device has a capability to perform the updating of the machine learning model based on difference information; that the user device has a capability to perform the updating of the machine learning model based on the machine learning model policy that includes the difference information for the machine learning model with respect to the model structure or model configuration parameters; or that the user device has a capability to perform the updating of the machine learning model based on the machine learning model policy that includes difference information with respect to one or more layers of the machine learning model; and/or that the user device has a capability to perform the updating of the machine learning model based on the machine learning model policy that includes difference information with respect to one or more biases or weights of the machine learning model.

Example 26. The method of any of Examples 24-25, wherein the transmitting, by the network node to the user device, the machine learning model policy comprises: transmitting, by the network node to the user device, the machine learning model policy that includes difference information that is based on or in accordance with the capabilities indication received by the network node from the user device.

Example 27. The method of any of Examples 24-26, further comprising: receiving, by the network node from the user device, information on, or relating to, at least one change performed by the user device to the machine learning model based on the machine learning model policy.

Example 28. An apparatus comprising: at least one processor; and at least one memory including computer program code; the at least one memory and the computer program code configured to, with the at least one processor, cause the apparatus at least to perform the method of any of Examples 24-27.

Example 29. A non-transitory computer-readable storage medium comprising instructions stored thereon that, when executed by at least one processor, are configured to cause a computing system to perform the method of any of Examples 24-27.

Example 30. An apparatus comprising means for performing the method of any of Examples 24-27.

Example 31. An apparatus (e.g., see FIG. 10) comprising: at least one processor (e.g., 1304, FIG. 10); and at least one memory (e.g., 1306, FIG. 10) including computer program code; the at least one memory and the computer program code configured to, with the at least one processor, cause the apparatus at least to: receive, by a network node from a user device, information indicating that the user device has a capability to perform at least one machine learning model update based on difference information; transmit, by the network node to the user device, a machine learning model policy associated with model update, wherein the machine learning model policy comprises at least one of the following, for reducing the overhead of with respect to transmitting a full machine learning model: difference information for a machine learning model with respect to model structure or model configuration parameters; difference information with respect to one or more weights or biases of the machine learning model; or difference information with respect to one or more layers of the machine learning model; and receive, by the network node from the user device, an indication of the at least one machine learning model update being carried out based on the machine learning model policy.

FIG. 10 is a block diagram of a wireless station or node (e.g., UE, user device, AP, BS, eNB, gNB, RAN node, network node, TRP, or other node) 1300 according to an example embodiment. The wireless station 1300 may include, for example, one or more (e.g., two as shown in FIG. 10) RF (radio frequency) or wireless transceivers 1302A, 1302B, where each wireless transceiver includes a transmitter to transmit signals and a receiver to receive signals. The wireless station also includes a processor or control unit/entity (controller) 1304 to execute instructions or software and control transmission and receptions of signals, and a memory 1306 to store data and/or instructions.

Processor 1304 may also make decisions or determinations, generate frames, packets or messages for transmission, decode received frames or messages for further processing, and other tasks or functions described herein. Processor 1304, which may be a baseband processor, for example, may generate messages, packets, frames or other signals for transmission via wireless transceiver 1302 (1302A or 1302B). Processor 1304 may control transmission of signals or messages over a wireless network, and may control the reception of signals or messages, etc., via a wireless network (e.g., after being down-converted by wireless transceiver 1302, for example). Processor 1304 may be programmable and capable of executing software or other instructions stored in memory or on other computer media to perform the various tasks and functions described above, such as one or more of the tasks or methods described above. Processor 1304 may be (or may include), for example, hardware, programmable logic, a programmable processor that executes software or firmware, and/or any combination of these. Using other terminology, processor 1304 and transceiver 1302 together may be considered as a wireless transmitter/receiver system, for example.

In addition, referring to FIG. 10, a controller (or processor) 1308 may execute software and instructions, and may provide overall control for the station 1300, and may provide control for other systems not shown in FIG. 10, such as controlling input/output devices (e.g., display, keypad), and/or may execute software for one or more applications that may be provided on wireless station 1300, such as, for example, an email program, audio/video applications, a word processor, a Voice over IP application, or other application or software.

In addition, a storage medium may be provided that includes stored instructions, which when executed by a controller or processor may result in the processor 1304, or other controller or processor, performing one or more of the functions or tasks described above.

According to another example embodiment, RF or wireless transceiver(s) 1302A/1302B may receive signals or data and/or transmit or send signals or data. Processor 1304 (and possibly transceivers 1302A/1302B) may control the RF or wireless transceiver 1302A or 1302B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. An apparatus comprising:
at least one processor; and
at least one memory including computer program code;
the at least one memory and the computer program code configured to, with the at least one processor, cause the apparatus at least to:
receive, by a user device, a machine learning model policy associated with model update, wherein the machine learning model policy comprises at least one of the following:
difference information for a machine learning model with respect to model structure or model configuration parameters;
difference information with respect to one or more weights or biases of the machine learning model; and
difference information with respect to one or more layers of the machine learning model;
carry out updating of the machine learning model according to the machine learning model policy; and
transmit, by the user device to a network node, information on at least one change to the machine learning model caused by the updating, for reducing overhead with respect to transmitting a full updated version of the machine learning model.

2. The apparatus of claim 1:
wherein the difference information with respect to model structure or model configuration parameters comprises difference information that indicates an amount or percentage that one or more of the configuration parameters of the machine learning model should be increased or decreased; and
wherein the difference information with respect to one or more weights or biases of the machine learning model comprises difference information provided for the machine learning model that indicates an amount or percentage that weights and/or biases of the machine learning model should be increased or decreased; and
wherein the difference information with respect to one or more layers of the machine learning comprises difference information provided for each of one or more layers of the machine learning model that indicates an amount or percentage that weights and/or biases of the layer of the machine learning model should be increased or decreased.

3. The apparatus of claim 1, wherein the at least one processor and the computer program code are configured to further cause the apparatus to:
transmit, by the user device to the network node, a request for the machine learning model policy; and
wherein the at least one processor and the computer program code configured to cause the apparatus to receive comprises the at least one processor and the computer program code configured to cause the apparatus to receive the machine learning model policy based on the request.

4. The apparatus of claim 1, wherein the machine learning model comprises a first version of the machine learning model, and wherein the difference information comprises a difference or delta between one or more weights, biases or layers of the first version of the machine learning model and one or more weights, biases or layers, respectively, of a second version of the machine learning model that is obtained based on the updating the first version of the machine learning model based on the difference information.

5. The apparatus of claim 4, wherein the difference information comprises:
a global difference information indicating a global difference for the machine learning model between one or more aspects or parameters of the first version of the machine learning model and one or more corresponding aspects or parameters of the second version of the machine learning model.

6. The apparatus of claim 1, wherein the difference information with respect to one or more layers comprises a vector difference information indicated for each of one or more layers, including difference information for one or more parameters of the layer of the machine learning model.

7. The apparatus of claim 1, wherein the difference information with respect to one or more layers comprises difference information indicated for each of one or more layers, including a first difference information for weights of the layer, and a second difference information for biases of the layer of the machine learning model.

8. The apparatus of claim 1, wherein the difference information comprises an indication of one or more layers of the machine learning model that are updated.

9. The apparatus of claim 1, wherein the difference information comprises a per parameter difference information for a subset of one or more weights or biases of the machine learning model.

10. The apparatus of claim 1, wherein the difference information comprises a difference or change in a state of the machine learning model, including an updated state or a change in a state of one or more parameters of the machine learning model, to be used by the user device for training or updating the machine learning model.

11. The apparatus of claim 1, wherein the difference information comprises information indicating a relationship between two or more consecutive layers of the machine learning model that have been updated.

12. The apparatus of claim 1, wherein the difference information comprises:
a correlation of weights and/or biases between consecutive layers of the machine learning model.

13. The apparatus of claim 1, wherein the difference information comprises at least one of:
a maximum difference for each layer of the machine learning model, before and after being updated;
a linear or non-linear computation indicating an amount or percentage that weights and/or biases of the machine learning model should be changed;
a correlation of weights and/or biases between multiple layers of the machine learning model;
a mean squared error, a maximum difference value, a percentile cumulative distribution function, or a cosine function that indicates an amount that weights and/or biases of the machine learning model should be changed; or
a mean squared error, a maximum difference value, or a percentile cumulative distribution function provided for each layer, that indicates an amount that the weights and/or biases of one or more layers of the machine learning model should be changed.

14. The apparatus of claim 1, wherein the machine learning model comprises a first version of the machine learning model, wherein the difference information comprises at least one of:
a maximum difference between weights of the first version of the machine learning model and weights of a second version of the machine learning model after being updated;
a linear or non-linear computation indicating a difference between weights and/or biases of the first version of the machine learning model and weights and/or biases of the second version of the machine learning model;
a mean squared error, a maximum difference value, a percentile cumulative distribution function, or a cosine function that indicates differences between weights and/or biases of the first version of the machine learning model and weights and/or biases of the second version of the machine learning model; or
a mean squared error, a maximum difference value, or a percentile cumulative distribution function provided for each of one or more layers, that indicates differences between weights and/or biases of a layer of the first version of the machine learning model and weights and/or biases of a same or corresponding layer of the second version of the machine learning model.

15. The apparatus of claim 1, wherein the at least one processor and the computer program code configured to cause the apparatus to transmit, by the user device to the network node, information on at least one change to the machine learning model caused by the updating comprises the at least one processor and the computer program code configured to cause the apparatus to transmit, by the user device to the network node, information indicating at least one of the following:
that one or more layers of the machine learning model were updated based on the difference information;
an indication of one or more weights and/or biases that were updated based on the difference information;
an amount that one or more weights and/or biases of the machine learning model were changed;
an indication that weights and/or biases of the machine learning model were changed by more than a threshold; or
an indication of one or more layers of the machine learning model for which weights and/or biases of the layer were changed by more than a threshold.

16. The apparatus of claim 1, wherein the machine learning model comprises a first version of the machine learning model, wherein the at least one processor and the computer program code configured to cause the apparatus to carry out updating comprises the at least one processor and the computer program code configured to cause the apparatus to update, by the user device based on the difference information, the machine learning model to obtain a second version of the machine learning model;
the at least one processor and the computer program code configured to further cause the apparatus to:
determine, by the user device, a measured general difference information based on a difference between weights of the second version of the machine learning model and the weights of the second version of the machine learning model; and
compare the measured general difference information to a threshold; and
wherein the at least one processor and the computer program code configured to cause the apparatus to transmit information on at least one change to the machine learning model comprises the at least one processor and the computer program code configured to cause the apparatus to transmit, by the user device to the network node, the measured general difference information to the network node if the measured general difference information is greater than the threshold.

17. The apparatus of claim 1, wherein the machine learning model comprises a first version of the machine learning model, wherein the at least one processor and the computer program code configured to cause the apparatus to carry out updating comprises the at least one processor and the computer program code configured to cause the apparatus to update, by the user device based on the difference information, the machine learning model to obtain a second version of the machine learning model;
the at least one processor and the computer program code configured to further cause the apparatus to:
determine, by the user device, a measured per layer difference information based on a difference, per layer, between weights of the second version of the machine learning model and the weights of the second version of the machine learning model; and
compare, for each layer of the machine learning model, each measured per layer difference information to a threshold;
wherein the at least one processor and the computer program code configured to cause the apparatus to transmit information on at least one change to the machine learning model comprises the at least one processor and the computer program code configured to cause the apparatus to transmit, by the user device to the network node, the measured per layer difference information, for one or more of the layers that have a measured per layer difference information that is greater than the threshold.

18. The apparatus of claim 1, wherein the at least one processor and the computer program code are configured to further cause the apparatus to:
transmit, by the user device to the network node, a capabilities indication that indicates at least one of the following:
that the user device has a capability to perform the updating of the machine learning model;
that the user device has a capability to perform the updating of the machine learning model based on difference information;
that the user device has a capability to perform the updating of the machine learning model based on the machine learning model policy that includes the difference information for the machine learning model with respect to the model structure or model configuration parameters;
that the user device has a capability to perform the updating of the machine learning model based on the machine learning model policy that includes difference information with respect to one or more layers of the machine learning model; or
that the user device has a capability to perform the updating of the machine learning model based on the machine learning model policy that includes difference information with respect to one or more biases or weights of the machine learning model.

19. The apparatus of claim 18, wherein the at least one processor and the computer program code are configured to further cause the apparatus to:
receive, by the user device from the network node, the machine learning model policy that includes the difference information that is based on or in accordance with the capabilities indication transmitted by the user device.

20. A method comprising:
receiving, by a user device, a machine learning model policy associated with model update, wherein the machine learning model policy comprises at least one of the following:
difference information for a machine learning model with respect to model structure or model configuration parameters;
difference information with respect to one or more weights or biases of the machine learning model; or
difference information with respect to one or more layers of the machine learning model;
carrying out updating of the machine learning model according to the machine learning model policy; and
transmitting, by the user device to a network node, information on at least one change to the machine learning model caused by the updating, for reducing overhead with respect to transmitting a full updated version of the machine learning model.

21. The method of claim 20:
wherein the difference information with respect to model structure or model configuration parameters comprises difference information that indicates an amount or percentage that one or more of the configuration parameters of the machine learning model should be increased or decreased; and
wherein the difference information with respect to one or more weights or biases of the machine learning model comprises difference information provided for the machine learning model that indicates an amount or percentage that weights and/or biases of the machine learning model should be increased or decreased; and
wherein the difference information with respect to one or more layers of the machine learning comprises difference information provided for each of one or more layers of the machine learning model that indicates an amount or percentage that weights and/or biases of the layer of the machine learning model should be increased or decreased.

22. The method of claim 20, further comprising:
transmitting, by the user device to the network node, a request for the machine learning model policy; and
wherein the receiving comprises receiving the machine learning model policy based on the request.

23. The method of claim 20, wherein the machine learning model comprises a first version of the machine learning model, and wherein the difference information comprises a difference or delta between one or more weights, biases or layers of the first version of the machine learning model and one or more weights, biases or layers, respectively, of a second version of the machine learning model that is obtained based on the updating the first version of the machine learning model based on the difference information.

24. The method of claim 23, wherein the difference information comprises:
a global difference information indicating a global difference for the machine learning model between one or more aspects or parameters of the first version of the machine learning model and one or more corresponding aspects or parameters of the second version of the machine learning model.

25. The method of claim 20, wherein the difference information with respect to one or more layers comprises a vector difference information indicated for each of one or more layers, including difference information for one or more parameters of the layer of the machine learning model.

26. The method of claim 20, wherein the difference information with respect to one or more layers comprises difference information indicated for each of one or more layers, including a first difference information for weights of the layer, and a second difference information for biases of the layer of the machine learning model.

27. An apparatus comprising:
at least one processor; and
at least one memory including computer program code;
the at least one memory and the computer program code configured to, with the at least one processor, cause the apparatus at least to:
receive, by a network node from a user device, information indicating that the user device has a capability to perform at least one machine learning model update based on difference information;
transmit, by the network node to the user device, a machine learning model policy associated with model update, wherein the machine learning model policy comprises at least one of the following, for reducing the overhead of with respect to transmitting a full machine learning model:
difference information for a machine learning model with respect to model structure or model configuration parameters;
difference information with respect to one or more weights or biases of the machine learning model; or
difference information with respect to one or more layers of the machine learning model; and
receive, by the network node from the user device, an indication of the at least one machine learning model update being carried out based on the machine learning model policy.

28. The apparatus of claim 27, wherein the capabilities indication comprises an indication of at least one of the following:
that the user device has a capability to perform the updating of the machine learning model;
that the user device has a capability to perform the updating of the machine learning model based on difference information;
that the user device has a capability to perform the updating of the machine learning model based on the machine learning model policy that includes the difference information for the machine learning model with respect to the model structure or model configuration parameters; or
that the user device has a capability to perform the updating of the machine learning model based on the machine learning model policy that includes difference information with respect to one or more layers of the machine learning model; and/or
that the user device has a capability to perform the updating of the machine learning model based on the machine learning model policy that includes difference information with respect to one or more biases or weights of the machine learning model.

29. The apparatus of claim 27, wherein the at least one processor and the computer program code configured to, with the at least one processor, cause the apparatus to transmit, by the network node to the user device, the machine learning model policy comprises the at least one processor and the computer program code configured to cause the apparatus to:
transmit, by the network node to the user device, the machine learning model policy that includes difference information that is based on or in accordance with the capabilities indication received by the network node from the user device.

30. The apparatus of claim 27, wherein the at least one processor and the computer program code are configured to further cause the apparatus to:
receive, by the network node from the user device, information on, or relating to, at least one change performed by the user device to the machine learning model based on the machine learning model policy.
